(19) United States
(12) Patent Application Publication
(10) Pub. No.: US 2025/0047691 A1
(43) Pub. Date: Feb. 6, 2025

(54) VEHICLE NETWORK SECURITY SYSTEM AND METHOD

(71) Applicants: HYUNDAI MOTOR COMPANY, Seoul (KR); KIA CORPORATION, Seoul (KR)

(72) Inventor: Ho Jin Jung, Bucheon-si (KR)

(73) Assignees: HYUNDAI MOTOR COMPANY, Seoul (KR); KIA CORPORATION, Seoul (KR)

(21) Appl. No.: 18/522,868

(22) Filed: Nov. 29, 2023

(30) Foreign Application Priority Data
Aug. 2, 2023 (KR) 10-2023-0101255

(51) Int. Cl. H04L 9/40

(52) U.S. Cl. CPC H04L 63/1416

(57) ABSTRACT

A vehicle network security system includes: an Ethernet switch that receives and decrypts encrypted data from a first vehicle controller; and a gateway that determines whether or not to transmit the decrypted data according to whether there is an error in the decrypted data when the decrypted data is received from the Ethernet switch.

### CROSS-REFERENCE TO RELATED APPLICATION

This application claims the benefit of and priority to Korean Patent Application No. 10-2023-0101255, filed in the Korean Intellectual Property Office on Aug. 2, 2023, the entire contents of which are incorporated herein by reference.

### TECHNICAL FIELD

The present disclosure relates to a vehicle network security system and method. More specifically, the present disclosure relates to a vehicle network security system and method applied in an Ethernet-based network (e.g., Local Area Network (LAN)) environment.

### BACKGROUND

Communication between vehicle controllers (or electronic control units (ECUs)) in a vehicle is generally performed through controller area network (CAN) communication. However, Ethernet has recently been introduced to communication between vehicle controllers because CAN communication is relatively slow.

When data is transmitted in an Ethernet-based network, an Ethernet frame having a standardized structure is used. Recently, as the security of data transmitted between vehicle controllers has been strengthened, Media Access Control Security (MACsec) has been applied to secure the confidentiality and integrity of Ethernet frames.

An Ethernet switch is required for Ethernet communication between vehicle controllers. The Ethernet switch extracts a destination address based on the destination Media Access Control (MAC) Address included in an Ethernet frame and transmits data to a vehicle controller corresponding to the destination address. Because the Ethernet switch is able to identify the destination MAC address even though MACsec is applied to the Ethernet frame, the Ethernet switch switches the data to the destination address. Therefore, even when the vehicle controller that has transmitted the data is hacked, the Ethernet switch may switch the hacked data to the destination address, and in this case, the vehicle may perform an abnormal operation, causing an accident and threatening the safety of a driver.

### SUMMARY

The present disclosure has been made to solve the above-mentioned problems while advantages achieved by the prior art are maintained intact.

An aspect of the present disclosure provides a vehicle network security system and method, which apply MACsec to a vehicle controller and a switch that perform Ethernet communication to verify the integrity of data transmitted from the vehicle controller to improve network security in an Ethernet-based network environment.

An aspect of the present disclosure provides a vehicle network security system and method, in which an Ethernet switch: decrypts the encrypted data using MACsec and then verifies an integrity check value when receiving encrypted data from a vehicle controller; and discards data to fundamentally block transmission of encrypted data to other vehicle controllers when the integrity check value is not verified.

An aspect of the present disclosure provides a vehicle network security system and method, in which an Ethernet switch decrypts the encrypted data using MACsec and then verifies an integrity check value when encrypted data is received from a vehicle controller and transmits the decrypted data to a gateway when the integrity check value is verified. The gateway encrypts the decrypted data and transmits it to other vehicle controllers only when there is no error in the payload of the decrypted data, to make Ethernet-based networks robust against hacking.

The technical problems to be solved by the present disclosure are not limited to the aforementioned problems. Any other technical problems not mentioned herein should be clearly understood from the following description by those of ordinary skill in the art to which the present disclosure pertains.

According to an aspect of the present disclosure, a vehicle network security system includes an Ethernet switch that receives and decrypts encrypted data from a first vehicle controller. The vehicle network security system further includes a gateway that determines whether or not to transmit the decrypted data according to whether there is an error in the decrypted data when the decrypted data is received from the Ethernet switch.

According to an embodiment, Media Access Control Security (MACsec) may be applied to the first vehicle controller and the Ethernet switch.

According to an embodiment, the gateway may include an Intrusion Detection and Prevention System (IDPS).

According to an embodiment, the Ethernet switch may determine whether an integrity check value of the decrypted data is successfully verified.

According to an embodiment, the Ethernet switch may discard the decrypted data and transmit discarded data information to the first vehicle controller when it is determined that the integrity check value of the decrypted data is not successfully verified.

According to an embodiment, the Ethernet switch may transmit the decrypted data to the gateway when it is determined that the integrity check value of the decrypted data is successfully verified.

According to an embodiment, the gateway may discard the decrypted data and transmit discarded data information to the first vehicle controller when there is an error in the decrypted data.

According to an embodiment, the gateway may transmit the decrypted data to the Ethernet switch when it is determined that there is no error in the decrypted data.

According to an embodiment, the Ethernet switch may encrypt the decrypted data and transmit encrypted data to a second vehicle controller when the decrypted data is received.

According to an embodiment, the second vehicle controller may receive and decrypt the encrypted data, and generate a vehicle control signal based on the decrypted data.

A vehicle network security method includes: receiving and decrypting, by an Ethernet switch, encrypted data from a first vehicle controller; and determining, by a gateway, whether or not to transmit the decrypted data according to whether there is an error in the decrypted data when the decrypted data is received from the Ethernet switch.

According to an embodiment, Media Access Control Security (MACsec) may be applied to the first vehicle controller and the Ethernet switch.

According to an embodiment, the gateway may include an Intrusion Detection and Prevention System (IDPS).

According to an embodiment, the vehicle network security method may further include determining whether an integrity check value of the decrypted data is successfully verified, after the receiving and decrypting of the encrypted data from the first vehicle controller by the Ethernet switch.

According to an embodiment, the vehicle network security method may further include discarding the decrypted data and transmitting discarded data information to the first vehicle controller when it is determined that the integrity check value of the decrypted data is not successfully verified.

According to an embodiment, the vehicle network security method may further include transmitting the decrypted data to the gateway when it is determined that the integrity check value of the decrypted data is successfully verified.

According to an embodiment, the vehicle network security method may further include discarding the decrypted data and transmitting discarded data information to the first vehicle controller when there is an error in the decrypted data, in determining whether or not to transmit the decrypted data according to whether there is an error in the decrypted data.

According to an embodiment, the vehicle network security method may further include transmitting the decrypted data to the Ethernet switch when it is determined that there is no error in the decrypted data, in determining whether or not to transmit the decrypted data according to whether there is an error in the decrypted data.

According to an embodiment, the vehicle network security method may further include encrypting, by the Ethernet switch, the decrypted data and transmitting encrypted data to a second vehicle controller when the decrypted data is received.

According to an embodiment, the vehicle network security method may further include receiving and decrypting, by the second vehicle controller, the encrypted data, and generating a vehicle control signal based on the decrypted data.

### BRIEF DESCRIPTION OF THE DRAWINGS

The above and other objects, features, and advantages of the present disclosure should be more apparent from the following detailed description taken in conjunction with the accompanying drawings:

FIG. 1 is a diagram showing a configuration of a vehicle network security system according to an embodiment of the present disclosure;

FIG. 2 is a diagram illustrating an Ethernet frame to which media access control security is applied;

FIG. 3 is a diagram showing a configuration of a vehicle controller according to an embodiment of the present disclosure;

FIG. 4 is a diagram showing a configuration of an Ethernet switch according to an embodiment of the present disclosure;

FIG. 5 is a diagram showing a configuration of a gateway according to an embodiment of the present disclosure;

FIG. 6 is a diagram schematically illustrating a communication method of a vehicle network security system according to an embodiment of the present disclosure;

FIG. 7 is a diagram illustrating a vehicle network security method according to an embodiment of the present disclosure; and

FIG. 8 illustrates a configuration of a computing system for executing a method according to an embodiment of the present disclosure.

### DETAILED DESCRIPTION

Hereinafter, some embodiments of the present disclosure are described in detail with reference to the drawings. In adding the reference numerals to the components of each drawing, it should be noted that the identical or equivalent component is designated by the identical numeral even when they are displayed on other drawings. Further, in describing embodiments of the present disclosure, a detailed description of well-known features or functions is ruled out in order not to unnecessarily obscure the gist of the present disclosure.

In describing components of embodiments according to the present disclosure, terms such as first, second, “A”, “B”, (a), (b), and the like may be used. These terms are merely intended to distinguish one component from another component, and the terms do not limit the nature, sequence, or order of the constituent components. Unless otherwise defined, all terms used herein, including technical or scientific terms, have the same meanings as those generally understood by those of ordinary skill in the art to which the present disclosure pertains. Such terms as those defined in a generally used dictionary are to be interpreted as having meanings equal to the contextual meanings in the relevant field of art and are not to be interpreted as having ideal or excessively formal meanings unless clearly defined as having such in the present application.

When a component, device, element, or the like, of the present disclosure, is described as having a purpose or performing an operation, function, or the like, the component, device, or element should be considered herein as being “configured to” meet that purpose or to perform that operation or function.

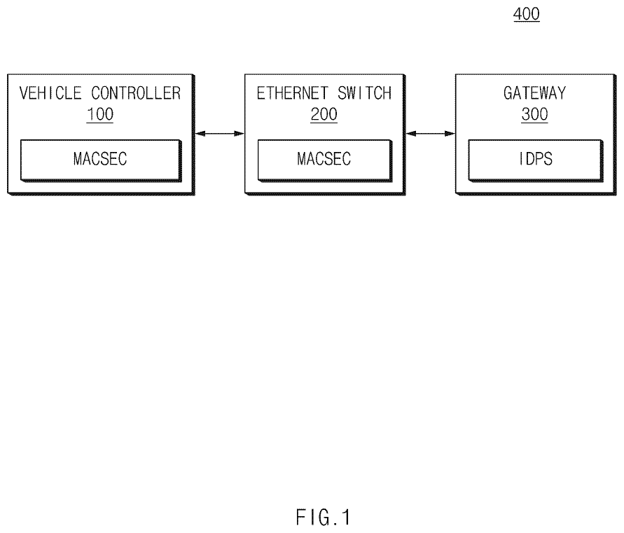

FIG. 1 is a diagram showing a configuration of a vehicle network security system according to an embodiment of the present disclosure.

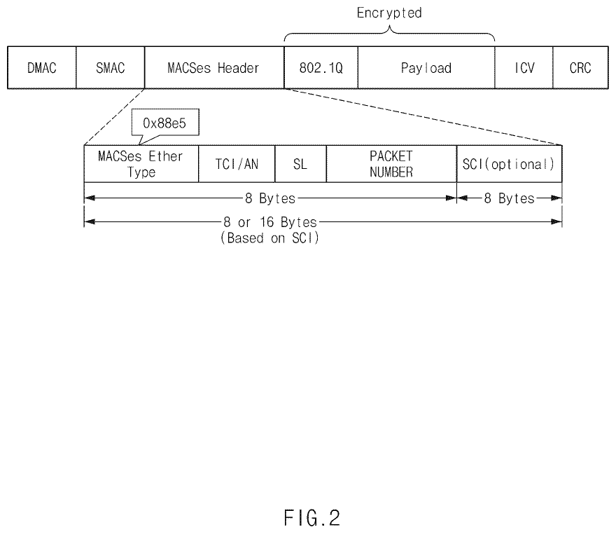

Referring to FIG. 1, a vehicle network security system 400 may include a vehicle controller 100, an Ethernet switch 200, and a gateway 300. The vehicle controller 100 may include electronic devices provided in a vehicle to control the vehicle and may include, for example, an Electronic Control Unit (ECU), a Vehicle Control Unit (VCU), and a Fuel Cell Control Unit (FCU). According to an embodiment, the vehicle controller 100 may collect vehicle information from various sensors in the vehicle and analyze the collected information to generate data including a control signal. According to an embodiment, the vehicle controller 100 may electronically control functions such as a smart key, digital cluster, brake, headlight, air conditioner, engine (motor) control, and cruise control. According to an embodiment, the vehicle controller 100 may encrypt data transmitted to the Ethernet switch 200 by applying media access control security (MACsec). A more detailed description of media access control security is described in more detail with reference to FIG. 2.

FIG. 2 is a diagram illustrating an Ethernet frame to which media access control security is applied.

Referring to FIG. 2, media access control security is a protocol operating in the L2 (data link) layer. The Ethernet frame to which media access control security is applied may include a destination Media Access Control address (DMAC), a source Media Access Control address (SMAC), a MACsec header, encrypted data (801.2Q standardized payload, data to be received by a vehicle controller at destination), an integrity check value (ICV), and a cycle redundancy check (CRC).

The Ethernet switch 200 may receive encrypted data from the vehicle controller 100 and decrypt encrypted messages. According to an embodiment, the Ethernet switch 200 may be provided with a pre-shared key in a sharing manner to decrypt encrypted data in the vehicle controller. The Ethernet switch 200 may decrypt the encrypted data received from the vehicle controller 100 based on the pre-shared key. The Ethernet switch 200 may verify an integrity check value of decrypted data by applying media access control security (MACsec) and determine whether the verification is successful. The Ethernet switch 200 may transmit the decrypted data to the gateway 300 when it is determined that the integrity check value of the decrypted data is successfully verified. In addition, when receiving the decrypted data from the gateway 300, the Ethernet switch 200 may encrypt the received data and transmit the encrypted data to other vehicle controllers.

The gateway 300 may include an intrusion detection and prevention system (IDPS) and determine whether there is an error in the decrypted data received from the Ethernet switch 200 using the intrusion detection and prevention system. Here, the intrusion detection and prevention system may be stored as an algorithm or implemented as hardware and installed in the gateway 300. When it is determined that there is no error in the decrypted data, the gateway 300 may transmit the decrypted data to the Ethernet switch 200.

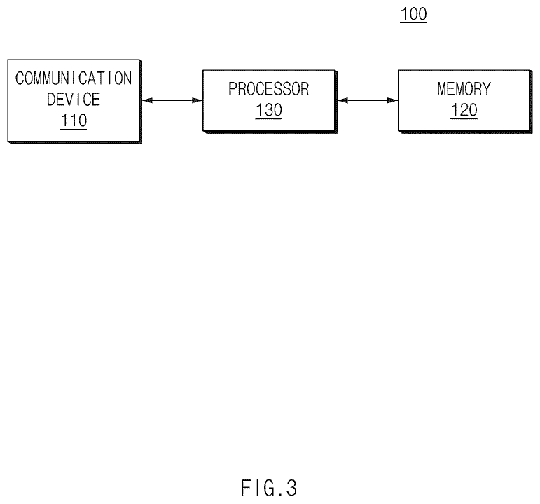

FIG. 3 is a diagram showing a configuration of a vehicle controller according to an embodiment of the present disclosure.

Referring to FIG. 3, the vehicle controller 100 may include a communication device 110, a memory 120, and a processor 130.

The communication device 110 may transmit data standardized as an Ethernet frame to the Ethernet switch 200 through Ethernet. The communication device 110 may be connected to the Ethernet switch 200 via a cable to perform wired communication with the Ethernet switch 200.

The memory 120 may store at least one or more algorithms for performing operations or execution of various commands for the operation of the vehicle controller according to an embodiment of the present disclosure. According to an embodiment, the memory 120 may store at least one instruction to be executed by the processor 130. The instruction may cause the vehicle controller of the present disclosure to operate. The memory 120 may store a pre-shared key for decryption when encrypted data is received. The memory 120 may include at least one medium of a flash memory, a hard disk, a memory card, a Read-Only Memory (ROM), a Random Access Memory (RAM), an Electrically Erasable Programmable Read-Only Memory (EEPROM) Memory, a Programmable Read-Only Memory (PROM), a magnetic memory, a magnetic disk, and an optical disk.

The processor 130 may be implemented by various processing devices incorporating a semiconductor chip capable of operating or executing various instructions or the like and may control an operation of the vehicle controller according to an embodiment of the present disclosure. The processor 130 may be electrically connected to the communication device 110, a sensor (not shown), and the memory 120 through wire cables or various circuits to transfer electrical signals including control commands and perform calculations or data processing related to control and/or communication. The processor 130 may include at least one of a central processing unit, an application processor, a communication processor (CP), or any combination thereof.

The processor 130 may encrypt data to be received by a vehicle controller at the destination by applying MACsec. The processor 130 may perform control to transmit encrypted data to the Ethernet switch 200.

When the encrypted data is received from the Ethernet switch 200, the processor 130 may decrypt the encrypted data with a pre-shared key stored in a memory and generate a vehicle control signal based on the decrypted data. Here, the vehicle control signal may include a signal for controlling overall operation of the vehicle.

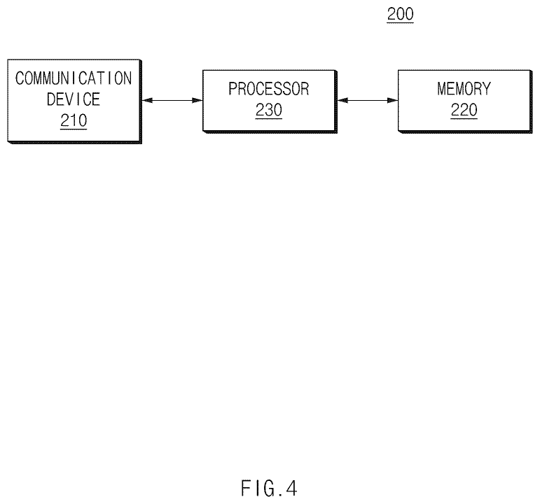

FIG. 4 is a diagram showing a configuration of an Ethernet switch according to an embodiment of the present disclosure.

Referring to FIG. 4, the Ethernet switch 200 may include a communication device 210, a memory 220, and a processor 230.

The communication device 210 may transmit data standardized as an Ethernet frame to the gateway 300 and the vehicle controller 100 through Ethernet. The communication device 210 may be connected to the gateway 300 and the vehicle controller 100 by a cable to perform wired communication with the gateway 300 and the vehicle controller 100.

The memory 220 may store at least one or more algorithms for performing operations or execution of various commands for the operation of the Ethernet switch according to an embodiment of the present disclosure. According to an embodiment, the memory 220 may store at least one instruction to be executed by the processor 230. The instruction may cause the Ethernet switch of the present disclosure to operate. In addition, the memory 220 may be provided with a pre-shared key stored in the vehicle controller in a sharing manner and store the pre-shared key. The pre-shared key may be used to decrypt encrypted data received from the vehicle controller. The memory 220 may include at least one medium of a flash memory, a hard disk, a memory card, a Read-Only Memory (ROM), a Random Access Memory (RAM), an Electrically Erasable Programmable Read-Only Memory (EEPROM) Memory, a Programmable Read-Only Memory (PROM), a magnetic memory, a magnetic disk, and an optical disk.

The processor 230 may be implemented by various processing devices incorporating a semiconductor chip capable of operating or executing various instructions or the like and may control an operation of the Ethernet switch according to an embodiment of the present disclosure. The processor 230 may be electrically connected to the communication device 210, and the memory 220 through wire cables or various circuits to transfer electrical signals including control commands and perform calculations or data processing related to control and/or communication. The processor 230 may include at least one of a central processing unit, an application processor, a communication processor (CP), or any combination thereof.

The processor 230 may decrypt the encrypted data received from the vehicle controller 100 using a pre-shared key.

The processor 230 may determine whether the integrity check value of the decrypted data is successfully verified. The processor 230 may determine that the integrity check value of the decrypted data is successfully verified when the decrypted data is not changed from the contents of the encrypted data.

The processor 230 may transmit the decrypted data to the gateway 300 when it is determined that the integrity check value of the decrypted data is successfully verified.

The processor 230 may discard the decrypted data when it is determined that the integrity check value of the decrypted data is not successfully verified. In addition, the processor 230 may store discarded data information in the memory 220 and transmit the discarded data information to the vehicle controller 100.

When receiving the decrypted data from the gateway 300, the processor 230 may encrypt the decrypted data by applying media access control security (MACsec) to the decrypted data. In addition, the processor 230 may transmit encrypted data to a vehicle controller connected to a port via which the decrypted data has been received.

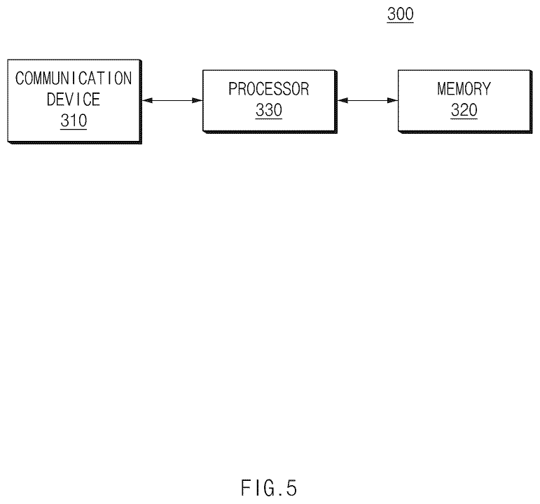

FIG. 5 is a diagram showing a configuration of a gateway according to an embodiment of the present disclosure.

Referring to FIG. 5, the gateway 300 may include a communication device 310, a memory 320, and a processor 330.

The communication device 310 may transmit data standardized as an Ethernet frame to the Ethernet switch 200 through Ethernet. The communication device 310 may be connected to the Ethernet switch 200 via a cable to perform wired communication with the Ethernet switch 200.

The memory 320 may store at least one or more algorithms for performing operations or execution of various commands for the operation of the gateway according to an embodiment of the present disclosure. According to an embodiment, the memory 320 may store at least one instruction to be executed by the processor 330. The instruction may cause the gateway of the present disclosure to operate. In addition, the memory 320 may store a rule-set of an intrusion detection and prevention system. Here, the rule-set of the intrusion detection and prevention system may include parameters (ID, transmission period, correlation, validity, or the like) for examining the contents of the payload of the Ethernet frame received by the gateway. The memory 320 may include at least one medium of a flash memory, a hard disk, a memory card, a Read-Only Memory (ROM), a Random Access Memory (RAM), an Electrically Erasable Programmable Read-Only Memory (EEPROM) Memory, a Programmable Read-Only Memory (PROM), a magnetic memory, a magnetic disk, and an optical disk.

The processor 330 may be implemented by various processing devices incorporating a semiconductor chip capable of operating or executing various instructions or the like and may control an operation of the Ethernet switch according to an embodiment of the present disclosure. The processor 330 may be electrically connected to the communication device 310 and the memory 320 through wire cables or various circuits to transfer electrical signals including control commands and perform calculations or data processing related to control and/or communication. The processor 330 may include at least one of a central processing unit, an application processor, a communication processor (CP), or any combination thereof.

When the decrypted data is received from the Ethernet switch 200, the processor 330 may determine whether or not there is an error in the decrypted data. According to an embodiment, the processor 330 may determine whether there is no error in the payload of the decrypted data based on a rule-set of the intrusion detection and prevention system.

According to an embodiment, the processor 330 may transmit the decrypted data to a port of the Ethernet switch 200 corresponding to a destination address when it is determined that there is no error in the decrypted data.

When it is determined that there is an error in the decrypted data, the processor 330 may discard the decrypted data, store the discarded data information in the memory 320, and transmit the discarded data information to the vehicle controller 100.

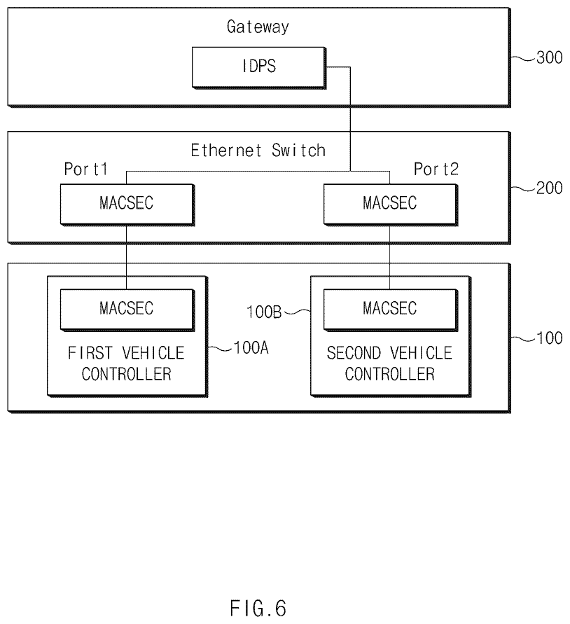

FIG. 6 is a diagram schematically illustrating a communication method of a vehicle network security system according to an embodiment of the present disclosure.

Referring to FIG. 6, data may be encrypted by applying media access control security (MACsec) to a first vehicle controller 100A. The first vehicle controller 100A may be connected to a first port of the Ethernet switch 200 by wire to transmit the encrypted data to the Ethernet switch 200.

The Ethernet switch 200 may receive and decrypt the encrypted data and determine whether the integrity check value of the decrypted data is successfully verified by applying media access control security (MACsec) to the Ethernet switch 200.

When it is determined that the integrity check value of the decrypted data is successfully verified, the Ethernet switch 200 may transmit the decrypted data to the gateway 300 connected by wire.

The gateway 300 may include an intrusion detection and prevention system (IDPS) and determine whether there is an error in the decrypted data received from the Ethernet switch 200 based on a rule-set of the intrusion detection and prevention system. When the gateway 300 determines that there is no error in the decrypted data, the gateway 300 may transmit the decrypted data to a port (e.g., a second port) corresponding to a destination address included in the decrypted data.

When the decrypted data is received from the gateway 300, the Ethernet switch 200 may encrypt the decrypted data by applying media access control security (MACsec) and transmit the encrypted data to a second vehicle controller 100B connected to a second port by wire.

The second vehicle controller 100B may receive and decrypt the encrypted data and generate a control signal for controlling the operation of the vehicle.

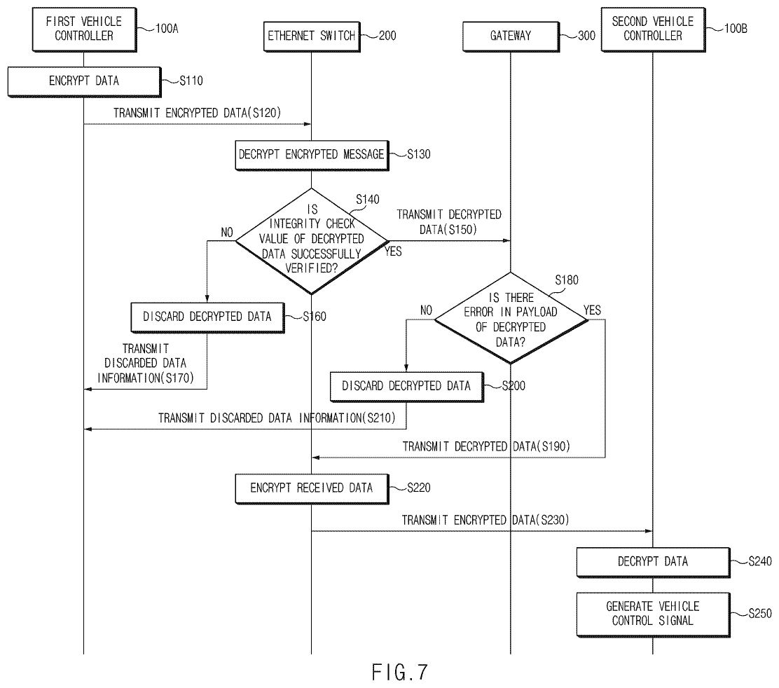

FIG. 7 is a diagram illustrating a vehicle network security method according to an embodiment of the present disclosure.

Referring to FIG. 7, the first vehicle controller 100A may encrypt data to be received by a destination vehicle controller (e.g., the second vehicle controller) by applying MACsec (S110).

The first vehicle controller 100A may perform control to transmit encrypted data to the Ethernet switch 200 (S120).

The Ethernet switch 200 may decrypt the encrypted data received from the first vehicle controller 100A using a pre-shared key (S130).

The Ethernet switch 200 may determine whether the integrity check value of the decrypted data is successfully verified (S140). In S140, the Ethernet switch 200 may determine that the integrity check value is successfully verified when the decrypted data is not changed from the contents of the encrypted data.

In S140, the Ethernet switch 200 may transmit the decrypted data to the gateway 300 when it is determined that the integrity check value of the decrypted data is successfully verified (S150).

On the other hand, when it is determined that the integrity check value of the decrypted data is not successfully verified in S140, the Ethernet switch 200 may discard the decrypted data (S160).

In addition, the Ethernet switch 200 may store the discarded data information in a memory and transmit the discarded data information to the vehicle controller 100 (S170).

When the decrypted data is received from the Ethernet switch 200, the gateway 300 may determine whether or not there is an error in the decrypted data (S180). In S180, the gateway 300 may determine whether there is no error in the payload of the decrypted data based on a rule-set of the intrusion detection and prevention system.

When it is determined that there is no error in the decrypted data in S180, the gateway 300 may transmit the decrypted data to a port of the Ethernet switch 200 corresponding to the destination address (S190).

When it is determined that there is an error in the decrypted data in S180, the gateway 300 may discard the decrypted data (S200). In addition, the gateway 300 may store discarded data information in a memory and transmit the discarded data information to the vehicle controller 100 (S210).

When receiving the decrypted data from the gateway 300, the Ethernet switch 200 may encrypt the decrypted data by applying media access control security (MACsec) to the decrypted data (S220). In addition, the Ethernet switch 200 may transmit the encrypted data to the second vehicle controller 100B connected to the port via which the decrypted data has been received (S230).

When the encrypted data is received from the Ethernet switch 200, the second vehicle controller 100B may decrypt the encrypted data using a pre-shared key stored in the memory (S240). In addition, the second vehicle controller 100B may generate a vehicle control signal based on the decrypted data (S250). Here, the vehicle control signal may include a signal for controlling overall operation of the vehicle.

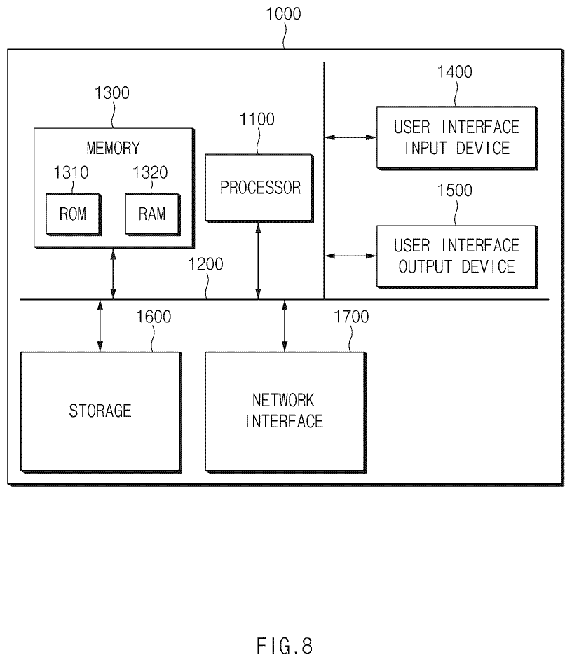

FIG. 8 illustrates a configuration of a computing system for executing a method according to an embodiment of the present disclosure.

Referring to FIG. 8, a computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a Read-Only Memory (ROM) 1310 and a Random-Access Memory (RAM) 1320.

Thus, the operations of the method or the algorithm described in connection with the embodiments disclosed herein may be embodied directly in hardware or a software module executed by the processor 1100, or in a combination thereof. The software module may reside on a storage medium (i.e., the memory 1300 and/or the storage 1600) such as a RAM, a flash memory, a ROM, an EPROM, an EEPROM, a register, a hard disk, a removable disk, and a compact disc ROM (CD-ROM). The storage medium may be coupled to the processor 1100, and the processor 1100 may read information out of the storage medium and may record information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

The above description is merely illustrative of the technical idea of the present disclosure, and various modifications and variations may be made without departing from the essential characteristics of the present disclosure by those of ordinary skill in the art to which the present disclosure pertains.

Accordingly, embodiments disclosed in the present disclosure are not intended to limit the technical idea of the present disclosure but to describe the present disclosure. The scope of the technical idea of the present disclosure is not limited by the disclosed embodiments. The scope of protection of the present disclosure should be interpreted by the following claims. All technical ideas within the scope equivalent thereto should be construed as being included in the scope of the present disclosure.

The vehicle network security system and method according to an embodiment of the present disclosure may apply MACsec to a vehicle controller and a switch that perform Ethernet communication to verify the integrity check value of data transmitted from the vehicle controller, thereby improving network security in an Ethernet-based network environment.

According to the vehicle network security system and method according to an embodiment of the present disclosure, when receiving encrypted data from a vehicle controller, an Ethernet switch may decrypt the encrypted data using MACsec and then verify an integrity check value. When the integrity check value is not verified, the Ethernet switch may discard data to fundamentally block transmission of encrypted data to other vehicle controllers.

According to the vehicle network security system and method according to an embodiment of the present disclosure, when encrypted data is received from a vehicle controller, an Ethernet switch may decrypt the encrypted data using MACsec and then verify an integrity check value. When the integrity check value is verified, the Ethernet switch may transmit the decrypted data to a gateway, and the gateway encrypts the decrypted data and transmits it to other vehicle controllers only when there is no error in the payload of the decrypted data, thereby making Ethernet-based networks robust against hacking.

Hereinabove, although the present disclosure has been described with reference to embodiments and the accompanying drawings, the present disclosure is not limited thereto, but may be variously modified and altered by those of ordinary skill in the art to which the present disclosure pertains without departing from the spirit and scope of the present disclosure claimed in the following claims.

What is claimed is:

1. A vehicle network security system comprising:
an Ethernet switch configured to receive and decrypt encrypted data from a first vehicle controller; and
a gateway configured to determine whether or not to transmit the decrypted data according to whether there is an error in the decrypted data when the decrypted data is received from the Ethernet switch.

2. The vehicle network security system of claim 1, wherein Media Access Control Security (MACsec) is applied to the first vehicle controller and the Ethernet switch.

3. The vehicle network security system of claim 1, wherein the gateway includes an Intrusion Detection and Prevention Systems (IDPS).

4. The vehicle network security system of claim 1, wherein the Ethernet switch is configured to determine whether an integrity check value of the decrypted data is successfully verified.

5. The vehicle network security system of claim 4, wherein the Ethernet switch is configured to discard the decrypted data and transmit discarded data information to the first vehicle controller when it is determined that the integrity check value of the decrypted data is not successfully verified.

6. The vehicle network security system of claim 4, wherein the Ethernet switch is configured to transmit the decrypted data to the gateway when it is determined that the integrity check value of the decrypted data is successfully verified.

7. The vehicle network security system of claim 1, wherein the gateway is configured to discard the decrypted data and transmit discarded data information to the first vehicle controller when there is an error in the decrypted data.

8. The vehicle network security system of claim 1, wherein the gateway is configured to transmit the decrypted data to the Ethernet switch when it is determined that there is no error in the decrypted data.

9. The vehicle network security system of claim 8, wherein the Ethernet switch is configured to encrypt the decrypted data and transmit encrypted data to a second vehicle controller when the decrypted data is received.

10. The vehicle network security system of claim 9, wherein the second vehicle controller is configured to receive and decrypt the encrypted data, and generate a vehicle control signal based on the decrypted data.

11. A vehicle network security method comprising:
receiving and decrypting, by an Ethernet switch, encrypted data from a first vehicle controller; and
determining, by a gateway, whether or not to transmit the decrypted data according to whether there is an error in the decrypted data when the decrypted data is received from the Ethernet switch.

12. The vehicle network security method of claim 11, wherein Media Access Control Security (MACsec) is applied to the first vehicle controller and the Ethernet switch.

13. The vehicle network security method of claim 11, wherein the gateway includes an Intrusion Detection and Prevention System (IDPS).

14. The vehicle network security method of claim 11, further comprising:
determining whether an integrity check value of the decrypted data is successfully verified, after the receiving and decrypting of the encrypted data from the first vehicle controller by the Ethernet switch.

15. The vehicle network security method of claim 14, further comprising:
discarding the decrypted data and transmitting discarded data information to the first vehicle controller when it is determined that the integrity check value of the decrypted data is not successfully verified.

16. The vehicle network security method of claim 14, further comprising:
transmitting the decrypted data to the gateway when it is determined that the integrity check value of the decrypted data is successfully verified.

17. The vehicle network security method of claim 11, further comprising:
discarding the decrypted data and transmitting discarded data information to the first vehicle controller when there is an error in the decrypted data, in determining whether or not to transmit the decrypted data according to whether there is an error in the decrypted data.

18. The vehicle network security method of claim 11, further comprising:
transmitting the decrypted data to the Ethernet switch when it is determined that there is no error in the decrypted data, in determining whether or not to transmit the decrypted data according to whether there is an error in the decrypted data.

19. The vehicle network security method of claim 18, further comprising:
encrypting, by the Ethernet switch, the decrypted data and transmitting encrypted data to a second vehicle controller when the decrypted data is received.

20. The vehicle network security method of claim 19, further comprising:
receiving and decrypting, by the second vehicle controller, the encrypted data; and
generating a vehicle control signal based on the decrypted data.
